(19) United States
(12) Patent Application Publication
(10) Pub. No.: US 2016/0063200 A1
(43) Pub. Date: Mar. 3, 2016

(54) ASSESSING RISKS FOR PROFESSIONALS

(71) Applicant: Brant Alan AVONDET, Highland, UT (US)

(72) Inventor: Brant Alan AVONDET, Highland, UT (US)

(21) Appl. No.: 14/839,767

(22) Filed: Aug. 28, 2015

Related U.S. Application Data
(60) Provisional application No. 62/042,906, filed on Aug. 28, 2014.

(51) Int. Cl. G06F 19/00

(52) U.S. Cl. CPC G06F 19/328; G06F 19/3425

(57) ABSTRACT

Malpractice risk and other risk factors can be associated with online ratings of professionals to assess and categorize malpractice risk and other risk factors for those professionals. Analysis of malpractice risk includes gathering online ratings data for professionals and analyzing the aggregated data in conjunction with malpractice or other risk data and other demographic information of the same or similar professionals to determine statistically significant correlations and algorithms. The process for using these risk algorithms to categorize risk includes aggregating online data for professionals and applying algorithms to categorize the risk of the professionals.

### CROSS-REFERENCE TO RELATED APPLICATIONS

This application claims the benefit of U.S. Provisional Patent Application Ser. No. 62/042,906, filed Aug. 28, 2014, and titled “ASSESSING RISKS FOR PROFESSIONALS,” the entire contents of which are hereby incorporated herein by reference.

### BACKGROUND

1. Field of the Current Disclosure

The present disclosure is generally related to risk assessment and insurance industries. More particularly, the present disclosure is related to determining the risk of malpractice claims against professionals.

2. Description of Related Art

To date, malpractice insurance entities have relied on publicly available demographic and claims data to create loss runs and properly price risk. For example, a physician's specialty, prior claims history, years of practice, gender, country of medical school, geographic location among others factors have been shown to correlate to malpractice risk and are inputted to an algorithm to generate an expected range of claims for the physician. Complex databases with hundreds of thousands of data points have been refined over decades to create these algorithms. It is fair to say that with the current data being used, the predictive capabilities are fairly optimized.

Malpractice insurance constructs have every incentive to incorporate the latest and greatest predictive capabilities. If other data sources are shown to be predictive of risk, malpractice insurance companies would need to adopt them or regulate their use. If they did not, they would risk other companies or individuals using these tools to create a Moral Hazard/Adverse Selection situation in which insurance company profits would be diminished.

Hospitals and medical groups also may currently be required by regulatory groups to conduct evaluations of providers on a periodic basis. Availability of data to evaluate the providers is currently one of the struggles for many facilities. Data from patients on their experience is difficult to obtain, especially for providers that do not treat a large number of patients at the facility and consequently are not included in these reviews. Furthermore, analysis of patient perceptions of providers may not be readily available today to help in evaluating providers for credentials or privileges to practice at a facility.

Other professions face the similar challenges of identifying predictive factors that can help stratify risk and also provide data for reviews and evaluations.

### SUMMARY

In one embodiment, a method for assessing a risk is disclosed. The method includes retrieving an item of online data pertaining to a professional and assessing the risk for the professional based, at least in part, on the item of online data.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope thereof to those skilled in the art.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram of an example of an architecture for implementing one embodiment;

FIG. 2 is a flow chart depicting an embodiment of a process for using online ratings, reviews, and comments to assess and present risk of professionals to users;

FIG. 3A depicts illustrative reviews of a professional;

FIG. 3B depicts an illustrative table of normalized risk parameters according to one embodiment of the present disclosure;

FIG. 3C depicts a report of risk for a professional according to one embodiment of the present disclosure; and

FIG. 4 is a flow chart depicting an embodiment of a process for using online ratings along with risk data to develop algorithms for assessing risk of professionals using online ratings, reviews, and comments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

The present disclosure extends to methods, systems, and computer programs for assessing, estimating, categorizing, stratifying, or otherwise determining the risk for malpractice, claims, future referrals, and/or future complaints of professionals or other services providers. In the following description, reference is made to the accompanying drawings that form a part hereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

One embodiment of the present disclosure comprises methods and/or systems for using ratings, reviews, comments or results of other survey instruments, or other online data from current or former users of a professional service in conjunction with the current art or in a stand-alone fashion to assess, categorize, stratify or otherwise determine the risk for malpractice, claims, future referrals, and/or future complaints of professionals. As used herein, such risk may be referred to as a “professional risk.”

Herein the term “online data” may include, but is not limited to, any information gathered from users, customers, relatives or friends of users or customers on an Internet based system and/or mobile computing system pertaining to any aspect of one or multiple encounters with a professional, including, but not limited to, any aspect of the interaction with the professional or staff or facility affiliated with the professional in person, on the phone, over the Internet, via mail, or otherwise before, during, or after the encounter with the professional. Examples of online data may include, but are not limited to, ratings, evaluations, reviews, comments, survey instruments, video or audio journals, posts, or blogs, comments on social media, photographs, search results, or recordings.

Herein the term “professional” may include, but is not limited to, any individual, firm, group, or other categorization of individuals who provide a service to an individual, firm, group, or other categorization of individuals. It is to be understood that the term “professional” is not limited to only those with professional licenses or designations such as physicians, nurses, accountants, and lawyers, but also may include individuals or staff that work with, around, and/or in the same facility as the professional from whom the customer, patient, client, or the like is seeking and/or has sought services. For example, healthcare professionals can include, but are not limited to, physicians, nurse practitioners, physician assistants, nursing staff, medical assistants, front desk and administrative staff, chiropractors, physical therapists, psychologists, dentists, dental hygienists, and other licensed and unlicensed professionals that treat health related issues for individuals. According to the present disclosure, professionals may provide services in a wide variety of fields, trades, and industries. In the present disclosure, the term “provider” may be essentially synonymous with the term “professional.”

Herein the term “risk” may include, but is not limited to, malpractice risk, risk of claims whether valid or invalid, risk of future referrals from other professionals or otherwise, risk of future complaints, risk of differing levels of satisfaction, and risk of poor outcomes from the service.

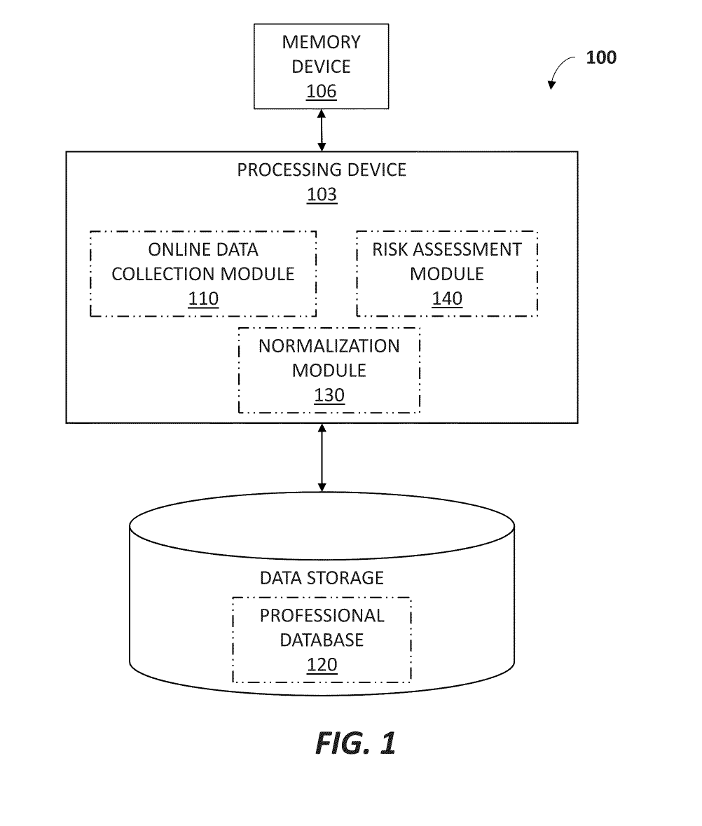

In one embodiment, at least part of the process for determining risk for professionals using online data may be implemented on one or more computing systems and/or one or more mobile computing systems. FIG. 1 is a block diagram depicting a risk assessment system 100 according to various embodiments of the present disclosure. An embodiment of risk assessment system 100 comprises online data collection module 110, professional database 120, normalization module 130, and risk assessment module 140.

An embodiment of online data collection module 110 comprises a computer processing device 103 and a memory 106 comprising computer-readable instructions directing processing device 103 to crawl webpages of targeted professional ratings systems and gather online data relating to one or more professionals. According to various embodiments of the present disclosure, online data collection module 110 can periodically gather information from professional ratings systems. In an embodiment, online data collection module 110 can receive an instruction to crawl a specific professional ratings system and/or seek online data regarding a particular professional and thus collect targeted online data.

Embodiments of professional database 120 comprise a database adapted to store collected online data and metadata regarding the circumstances of the collection of the online data. As used herein, the term “database” may include, but is not limited to, any data record collection type known at the time of filing, or as developed thereafter, such as, but not limited to, a database implemented on a hard drive or memory; a designated server system or computing system, or a designated portion of one or more server systems or computing systems; a server system network; a distributed database; or an external and/or portable hard drive. Herein, the term “database” can refer to a dedicated mass storage device implemented in software, hardware, or a combination of hardware and software. Herein, the term “database” can refer to an on-line function. Herein, the term “database” can refer to any data storage means that is part of, or under the control of, any computing system, as discussed herein, known at the time of filing, or as developed thereafter.

According to embodiments, normalization module 130 comprises computer processing device 103 and memory 106 comprising computer-readable instructions directing computer processor 103 to clean and normalize online data collected by collection module 110 and stored at professional database 120. In one embodiment, normalizing the online data may include removing duplicate data items, identifying and resolving name permutations of professionals, indexing the online data, organizing the online data to standard data parameters or data fields, and/or otherwise cleaning the online data stored at professional database 120.

Embodiments of risk assessment module 140 comprise computer processing device 103 and memory 106 comprising computer-readable instructions directing computer processor 103 to determine one or more professional(s)' risk relative to other similar professionals. A determination of risk may take into account some or all of the following factors: specialty, license, gender, years in the field, years of practice, professional school, geography of professional school, ongoing education, marital or relationship status, similar online data, geography, previous claims and/or malpractice, experience, cost of services, professional designations, membership to clubs, associations, fraternities or other groups, criminal or civil offenses, professional or business organization sanctions, discipline, or other actions, awards, distinctions, or other positive or negative designations or findings.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

In one embodiment of the present disclosure, the term “professional ratings” system may include, but is not limited to, any of the following: online sites that gather online data from users of services, examples of which include but are not limited to healthgrades.com™, vitals.com™, wellness.com™, ratemds.com™, drscore.com™, zocdoc.com™, angieslist.com™, ucomparehealthcare.com™, mydochub.com™, doctorscorecard.com™, bookofdoctors.com™, mdnationwide.org™, healthcarereviews.com™, social media sites, examples of which may include, but are not limited to, facebook™, google+™, Instagram™, twitter™, reddit™, systems at facilities that gather feedback from users of the service, examples of which may include, but are not limited to, patient complaints gathered by ombudsmen at hospitals, staff issue reporting systems at hospitals or law firms, databases and systems operated and made available on the internet for free or for a fee by public or private bodies that collect complaints or other user data, examples of which may include Better Business Bureau™, Consumer Reports™, and local chamber of commerce web sites.

In one embodiment of the present disclosure, the term “professional risk” systems includes, but is not limited to, any of the following: state or federal or industry association databases or systems, applications, web sites, or other stores of for example, but not limited to, claims, malpractice, sanctions, awards, designations, licenses, demographics of professionals, education, continuing education, credit, internet usage, or other pertinent information to the risk of a professional, or an institution, business, or private databases of professional risk data such as, but not limited to, databases, tools, systems, processes used by insurance constructs including but not limited to malpractice insurers, malpractice re-insurers, captives, and risk retention groups, to determine risk and premiums. Specific examples of professional risk systems include, but are not limited to the National Practitioner Databank™ “the Data Bank”, the State of Florida Medical Quality Assurance Services database, the State of Florida Office of Insurance Regulation Professional Liability Claims Reporting database, PIAA™ Data Sharing Project™ and associated databases.

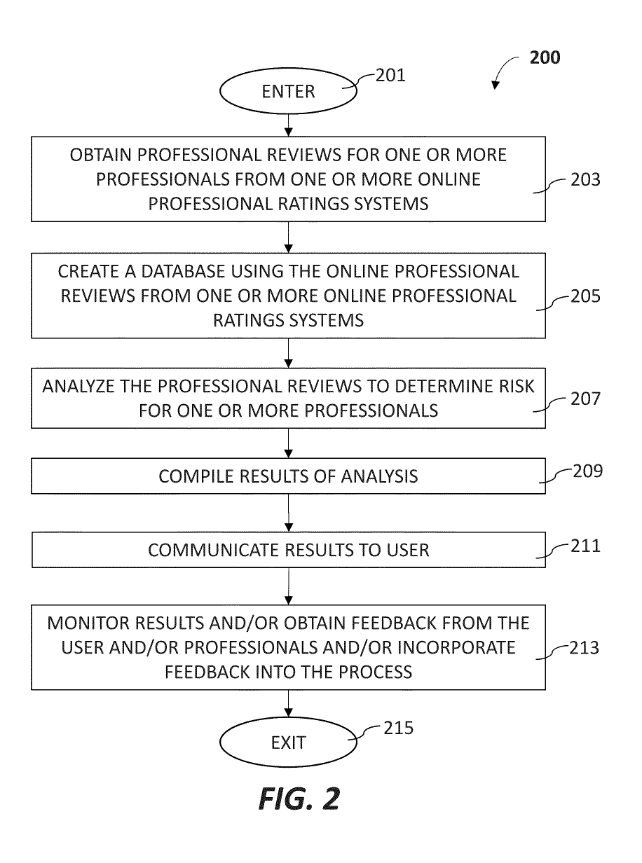

FIG. 2 is a flow chart depicting an embodiment of a process for using online ratings, reviews, and comments to assess and present risk of professionals 200, herein also referred to as process for using online data to assess and present risk of professionals 200, in accordance with one embodiment. Process for using online data to assess and present risk of professionals 200 begins at ENTER 201 and process flow proceeds to OBTAIN PROFESSIONAL REVIEWS FOR ONE OR MORE PROFESSIONALS FROM ONE OR MORE ONLINE PROFESSIONAL RATINGS SYSTEMS 203.

In one embodiment, at least part of the process for using online data to assess and present risk of professionals 200 is implemented on a computing system, and/or a mobile computing system, such as risk assessment system 100 of FIG. 1.

In one embodiment, at OBTAIN PROFESSIONAL REVIEWS FOR ONE OR MORE PROFESSIONALS FROM ONE OR MORE ONLINE PROFESSIONAL RATINGS SYSTEMS 203, online data is gathered from one or more professional ratings systems and may be temporarily stored in a memory before proceeding to CREATE A DATABASE USING THE ONLINE PROFESSIONAL REVIEWS FROM ONE OR MORE ONLINE PROFESSIONAL RATINGS SYSTEMS 205.

In one embodiment, at OBTAIN PROFESSIONAL REVIEWS FOR ONE OR MORE PROFESSIONALS FROM ONE OR MORE ONLINE PROFESSIONAL RATINGS SYSTEMS 203, online data is gathered from one or more professional ratings systems and may be entered directly into the database as part of CREATE A DATABASE USING THE ONLINE PROFESSIONAL REVIEWS FROM ONE OR MORE ONLINE PROFESSIONAL RATINGS SYSTEMS 205.

In one embodiment, at OBTAIN PROFESSIONAL REVIEWS FOR ONE OR MORE PROFESSIONALS FROM ONE OR MORE ONLINE PROFESSIONAL RATINGS SYSTEMS 203, online data from one or more professional ratings systems may already reside in a database that has a sufficient level of information and would not need to be added to a separate database or the existing database could be used to add other data to be processed in carrying out one or more operations from process 200 or as part of CREATE A DATABASE USING THE ONLINE PROFESSIONAL REVIEWS FROM ONE OR MORE ONLINE PROFESSIONAL RATINGS SYSTEMS 205.

Returning to FIG. 2, in one embodiment, once online data are obtained at OBTAIN PROFESSIONAL REVIEWS FOR ONE OR MORE PROFESSIONALS FROM ONE OR MORE ONLINE PROFESSIONAL RATINGS SYSTEMS 203, process flow proceeds to CREATE A DATABASE USING THE ONLINE PROFESSIONAL REVIEWS FROM ONE OR MORE ONLINE PROFESSIONAL RATINGS SYSTEMS 205.

In one embodiment, at CREATE A DATABASE USING THE ONLINE PROFESSIONAL REVIEWS FROM ONE OR MORE ONLINE PROFESSIONAL RATINGS SYSTEMS 205 a professional database is created using the online data relating to the professionals obtained at OBTAIN PROFESSIONAL REVIEWS FOR ONE OR MORE PROFESSIONALS FROM ONE OR MORE ONLINE PROFESSIONAL RATINGS SYSTEMS 203.

In one embodiment, at CREATE A DATABASE USING THE ONLINE PROFESSIONAL REVIEWS FROM ONE OR MORE ONLINE PROFESSIONAL RATINGS SYSTEMS 205 the online data pertaining to the professional are stored in the professional database based on one or more parameters related to the professional or online data, for which examples of the parameters include, but are not limited to, the following: name, license, years of practice, specialty, gender, identification number or other identifying indicia, date of online data, and category of online data.

In one embodiment, at CREATE A DATABASE USING THE ONLINE PROFESSIONAL REVIEWS FROM ONE OR MORE ONLINE PROFESSIONAL RATINGS SYSTEMS 205 the online data pertaining to the professional are normalized according to various practices known at the time of filing or developed thereafter and stored according to one or more parameters related to the professional or online data.

In one embodiment, at CREATE A DATABASE USING THE ONLINE PROFESSIONAL REVIEWS FROM ONE OR MORE ONLINE PROFESSIONAL RATINGS SYSTEMS 205 the data are cleaned according to various practices known at the time of filing or developed thereafter including, but not limited to, identifying permutations of professionals' names, identifying duplicate online data or specific elements of online data, combining professionals, deduplicating multiple redundant entries corresponding to a professional, indexing, identifying potential outliers or inaccurate data, and including or excluding data as appropriate in the cleaned professional database.

In one embodiment, at CREATE A DATABASE USING THE ONLINE PROFESSIONAL REVIEWS FROM ONE OR MORE ONLINE PROFESSIONAL RATINGS SYSTEMS 205 the online data may already be present in whole or in part in an existing database that can be used to carry out one or more operations from process 200.

In one embodiment, at CREATE A DATABASE USING THE ONLINE PROFESSIONAL REVIEWS FROM ONE OR MORE ONLINE PROFESSIONAL RATINGS SYSTEMS 205 other data such as, but not limited to, descriptive factors of the professional or their staff or environment, other reviews not gathered from professional review systems or data related to the professionals such as past claims, referrals, practice locations and geographies, photographs, audio or video recordings, social media references, search results, and blogs are included in the professional database in whole or in part.

In one embodiment, at CREATE A DATABASE USING THE ONLINE PROFESSIONAL REVIEWS FROM ONE OR MORE ONLINE PROFESSIONAL RATINGS SYSTEMS 205 other data such as, but not limited to, descriptive factors of the professional or their staff or environment, other reviews or data related to the professional such as past claims, referrals, practice locations and geographies, photographs, audio or video recordings, social media references, and blogs that reside in part or in whole in one or more separate databases from the professional database but are correlated to the online data in the professional database to aid in the analysis of the professional.

In one embodiment, once a professional database is created using the online data for one or more providers obtained at OBTAIN PROFESSIONAL REVIEWS FOR ONE OR MORE PROFESSIONALS FROM ONE OR MORE ONLINE PROFESSIONAL RATINGS SYSTEMS 203 at CREATE A DATABASE USING THE ONLINE PROFESSIONAL REVIEWS FROM ONE OR MORE ONLINE PROFESSIONAL RATINGS SYSTEMS 205, process flow proceeds to ANALYZE THE PROFESSIONAL REVIEWS TO DETERMINE RISK FOR ONE OR MORE PROVIDERS 207.

In one embodiment of the present disclosure, at ANALYZE THE PROFESSIONAL REVIEWS TO DETERMINE RISK FOR ONE OR MORE PROVIDERS 207 analysis can include, but is not limited to, algorithms or other classification schemes that determine one or more professional(s)' risk relative to other similar professionals that may be defined as similar by a factor or factors that include, but are not limited to, the following examples: specialty, license, gender, years in the field, years of practice, professional school, geography of professional school, ongoing education, marital or relationship status, similar online ratings or reviews for other providers (i.e., other service providers with similar ratings), geography, previous claims and/or malpractice, experience, cost of services, professional designations, membership in clubs, associations, fraternities or other groups, criminal or civil offenses, professional or business organization sanctions, discipline, or other actions, awards, distinctions, or other positive or negative designations or findings.

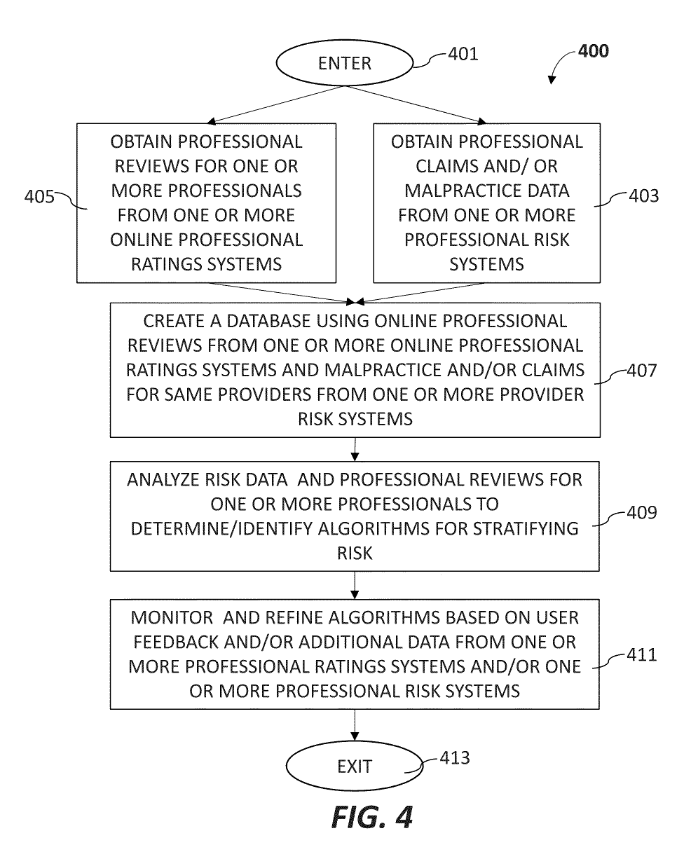

In one embodiment of the present disclosure, at ANALYZE THE PROFESSIONAL REVIEWS TO DETERMINE RISK FOR ONE OR MORE PROVIDERS 207 analysis can include, but is not limited to, an algorithm or algorithms that are developed, improved, and/or refined using online data gathered as part of or separate from process for using online data to assess and present risk of professionals 200, which is further discussed below in the discussion with respect to FIG. 4.

In one embodiment of the present disclosure, at ANALYZE THE PROFESSIONAL REVIEWS TO DETERMINE RISK FOR ONE OR MORE PROVIDERS 207 analysis can include, but is not limited to, automated analysis without the intervention of a user or provider of process for using online data to assess and present risk of professionals 200, manual (in that it requires the intervention of a user or provider of process for using online data to assess and present risk of professionals 200), or a mix of automated and manual processes.

In one embodiment, at ANALYZE THE PROFESSIONAL REVIEWS TO DETERMINE RISK FOR ONE OR MORE PROVIDERS 207 analysis may be completed in part or in whole using one or more computing systems or mobile computing systems.

In one embodiment, once analysis is completed using online data for one or more providers obtained at OBTAIN PROFESSIONAL REVIEWS FOR ONE OR MORE PROFESSIONALS FROM ONE OR MORE ONLINE PROFESSIONAL RATINGS SYSTEMS 203 in the database created at CREATE A DATABASE USING THE ONLINE PROFESSIONAL REVIEWS FROM ONE OR MORE ONLINE PROFESSIONAL RATINGS SYSTEMS 205 at ANALYZE THE PROFESSIONAL REVIEWS TO DETERMINE RISK FOR ONE OR MORE PROVIDERS 207, process flow proceeds to COMPILE RESULTS OF ANALYSIS 209.

In one embodiment, at COMPILE RESULTS OF ANALYSIS 209 the results of analysis at ANALYZE THE PROFESSIONAL REVIEWS TO DETERMINE RISK FOR ONE OR MORE PROVIDERS 207 can be compiled in part or in whole using a computing system.

In one embodiment, at COMPILE RESULTS OF ANALYSIS 209 the results of analysis at ANALYZE THE PROFESSIONAL REVIEWS TO DETERMINE RISK FOR ONE OR MORE PROVIDERS 207 can be compiled such that they can be communicated using in part or in whole a computing system.

In one embodiment, at COMPILE RESULTS OF ANALYSIS 209 the results of analysis at ANALYZE THE PROFESSIONAL REVIEWS TO DETERMINE RISK FOR ONE OR MORE PROVIDERS 207 can be compiled such that they can be made available using paper, fax, or another methodology using in part or whole or not using a computing system.

In one embodiment, at COMPILE RESULTS OF ANALYSIS 209 the results of analysis at ANALYZE THE PROFESSIONAL REVIEWS TO DETERMINE RISK FOR ONE OR MORE PROVIDERS 207 are compiled to include additional data or descriptive factors about the professional or professionals about which the analysis is being completed such as, but not limited to, professional specialty, license number, disciplinary actions, awards, credentials, gender, photo or video, and portions of online data such as comments.

In one embodiment, at COMPILE RESULTS OF ANALYSIS 209 the results of analysis at ANALYZE THE PROFESSIONAL REVIEWS TO DETERMINE RISK FOR ONE OR MORE PROVIDERS 207 are compiled to include trending of risk analysis or other factors such as, but not limited to, comments, number of ratings, and/or ranking verses peers or other professionals.

In one embodiment, once the result or results of risk analysis performed at ANALYZE THE PROFESSIONAL REVIEWS TO DETERMINE RISK FOR ONE OR MORE PROVIDERS 207 have been compiled at COMPILE RESULTS OF ANALYSIS 209 the process flow proceeds to COMMUNICATE RESULTS TO USER 211.

In one embodiment of this disclosure, at COMMUNICATE RESULTS TO USER 211 the user may receive results of analysis compiled in COMPILE RESULTS OF ANALYSIS 209 in part or in whole via a computing system using, but not limited to, one or more of the following examples of accessing results via a computing system: access to a web site, email, flash drive, disk, or accessing a terminal on which results have been compiled, or any combination of the aforementioned methods of communicating via a computing system.

In one embodiment of this disclosure, at COMMUNICATE RESULTS TO USER 211 the user is not the actual or potential consumer of the professional's services but is another individual or entity such as, but not limited to, a current, prospective, or past employer of the professional, a partner or manager of the professional, an insurance provider or potential insurance provider for the professional or other similar professionals, one or more business associates or peer or peers of the professional, or individuals or organizations involved in the review or evaluation of the professional.

In one embodiment of this disclosure, at COMMUNICATE RESULTS TO USER 211 the user includes, but is not limited to, a past, present, or potential consumer or consumers of the professional's or professionals' service or services.

In one embodiment of this disclosure, at COMMUNICATE RESULTS TO USER 211 the user may receive results of risk analysis compiled in COMPILE RESULTS OF ANALYSIS 209 in part or in whole via paper or other communication method such as phone, in person conversation, presentation, fax, mail, or other communication methodology in the current art or that may be developed in the future.

In various embodiments of the present disclosure, at optional operation MONITOR RESULTS AND/OR OBTAIN FEEDBACK FROM THE USER AND/OR PROFESSIONALS AND/OR INCORPORATE FEEDBACK INTO THE PROCESS 213 any feedback or additional data obtained is used by the provider of process for using online data to assess and present risk of professionals 200 to improve future analysis, compilation, and/or communication of risk.

In one embodiment of the present disclosure, at MONITOR RESULTS AND/OR OBTAIN FEEDBACK FROM THE USER AND/OR PROFESSIONALS AND/OR INCORPORATE FEEDBACK INTO THE PROCESS 213 additional data on the accuracy of risk determinations for professionals provided to user in COMMUNICATE RESULTS TO USER 211 is gathered and used improve future analysis, compilation, and/or communication of risk of professionals.

In one embodiment of the present disclosure, once the results are provided to the user at COMMUNICATE RESULTS TO USER 211 and are tracked, monitored, and other feedback received and incorporated back into the process at optional operation MONITOR RESULTS AND/OR OBTAIN FEEDBACK FROM THE USER AND/OR PROFESSIONALS AND/OR INCORPORATE FEEDBACK INTO THE PROCESS 213 process flow proceeds to EXIT 215.

In one embodiment, at EXIT 215 process for using online data to assess and present risk of professionals 200 is exited to await new data or requests for analysis of professionals. According to various embodiments, process 200 may be cycled repeatedly as additional data become available for entry into and/or analysis by risk assessment system 100 or as requests for further analysis are made.

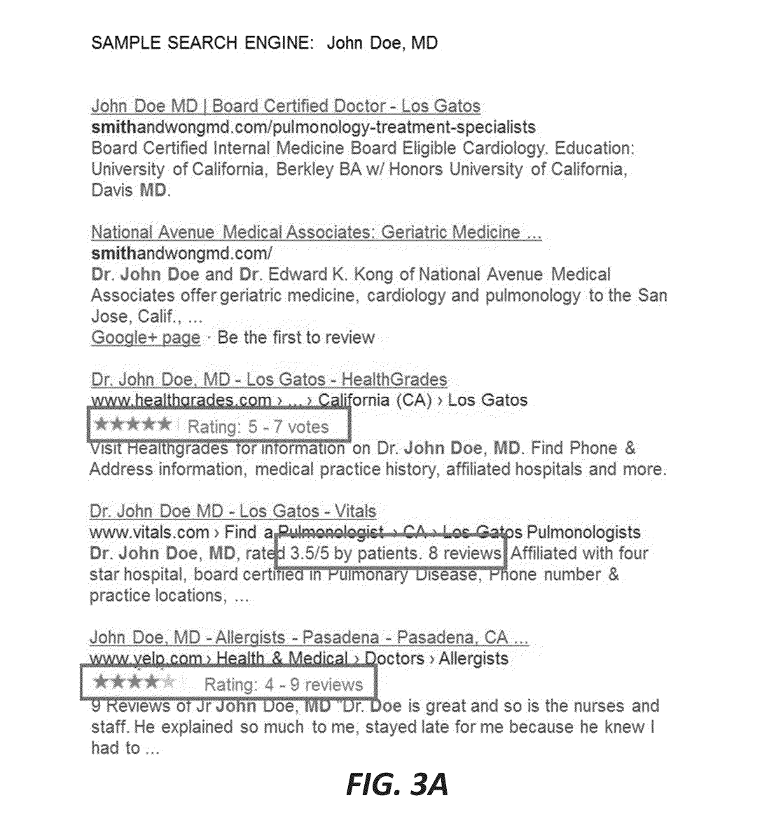

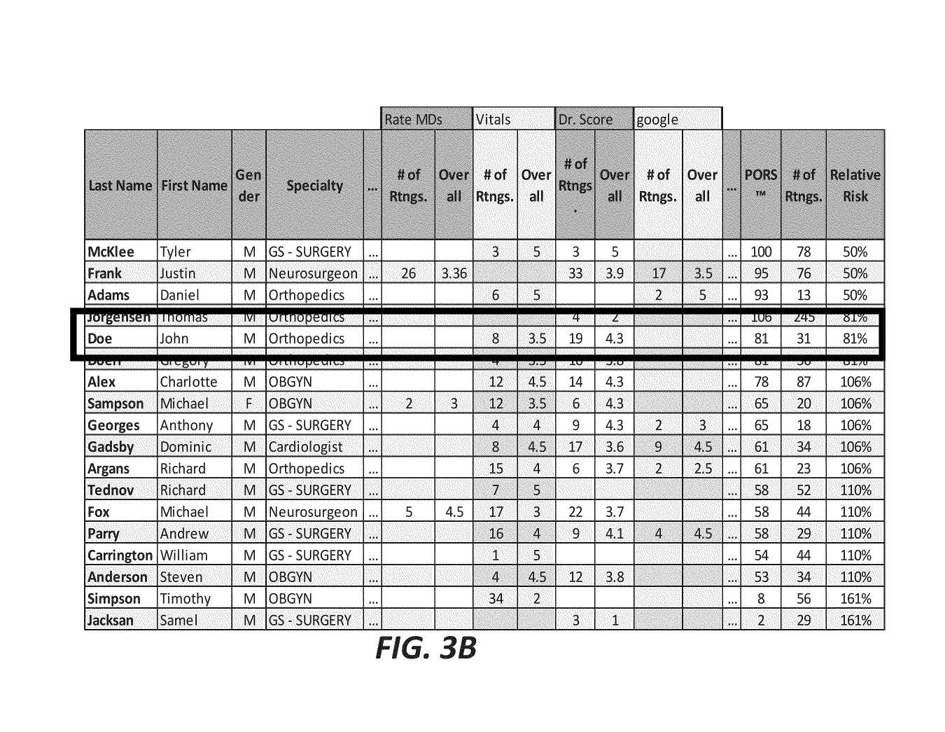

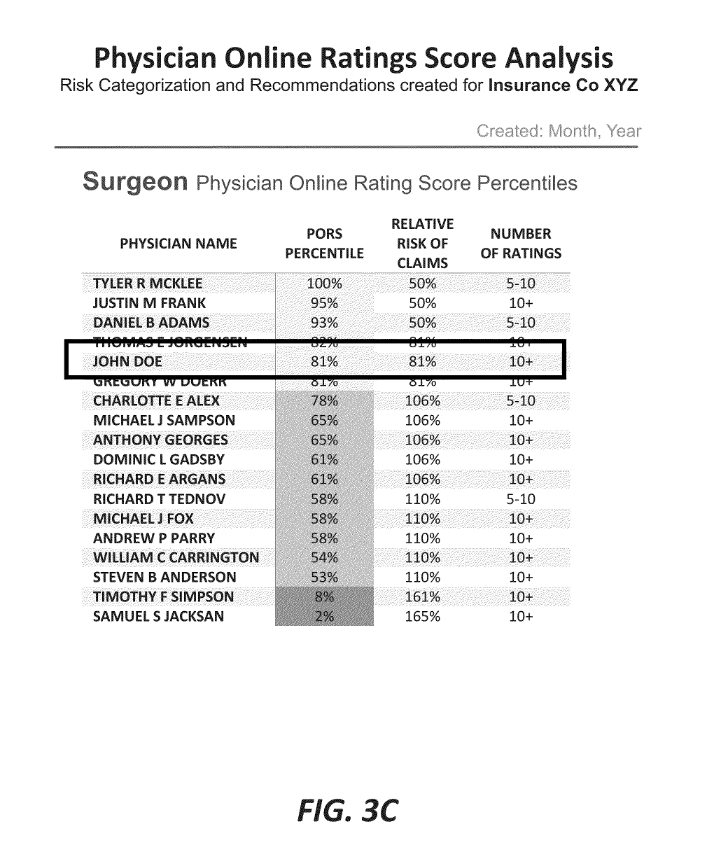

In one illustrative embodiment, process for using online data to assess and present risk of professionals 200 begins when online data collection module 110 indexes a webpage that has reviews of one or more professionals. Referring now to FIG. 3A, several reviews, with associated ratings, relating to a professional named John Doe are identified. Online data collection module 110 collects the reviews and ratings for John Doe and transmits the same to normalization module 130.

Normalization module 130 organizes the reviews and ratings to fit predetermined parameters. In this illustrative embodiment, the predetermined parameters are: name, professional area of specialty, years of experience, gender, identification number, date of retrieval of the online data, and category of online data. The data are then stored at professional database 120. FIG. 3B illustrates an exemplary set of values normalized and stored according to the selected such parameters at professional database 120.

The normalized data at professional database 120 can then be analyzed by risk assessment module 140 to determine the professional's professional risk relative to other similar professionals according to the recorded parameter values. For example, it may be determined that a male professional having 5 years of experience in the orthopedic surgery specialty is in the second decile (10^{th} to 20^{th} percentile) for risk of malpractice claims. The results of this analysis are then reported to interested users as depicted in FIG. 3C.

FIG. 4 is a flow chart depicting one embodiment of a process for using online ratings, reviews, and comments to determine or identify algorithms for stratifying risk for professionals 400, herein also referred to as process for using online data to determine risk for professionals 400. Process for using online data to determine risk for professionals 400 begins at ENTER 401 and process flow proceeds to one or both in any order or simultaneously OBTAIN PROFESSIONAL REVIEWS FOR ONE OR MORE PROFESSIONALS FROM ONE OR MORE ONLINE PROFESSIONAL RATINGS SYSTEMS 405 and OBTAIN PROFESSIONAL CLAIMS AND/OR MALPRACTICE DATA FROM ONE OR MORE PROFESSIONAL RISK SYSTEMS 403.

In one embodiment, at least part of process for using online data to determine risk for professionals 400 may be implemented on a computing system, and/or a mobile computing system, such as risk assessment system 100 of FIG. 1.

In one embodiment, at OBTAIN PROFESSIONAL CLAIMS AND/OR MALPRACTICE DATA FROM ONE OR MORE PROFESSIONAL RISK SYSTEMS 403, actual past claims and/or malpractice or estimated risk data from one or more professional risk systems is gathered from one or more professional risk systems and may be temporarily stored in memory before proceeding to CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at OBTAIN PROFESSIONAL CLAIMS AND/OR MALPRACTICE DATA FROM ONE OR MORE PROFESSIONAL RISK SYSTEMS 403, actual past claims and/or malpractice or estimated risk data from one or more professional risk systems is gathered from one or more professional risk systems and may be entered directly into the database as part of CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at OBTAIN PROFESSIONAL CLAIMS AND/OR MALPRACTICE DATA FROM ONE OR MORE PROFESSIONAL RISK SYSTEMS 403, actual historical claims and/or historical malpractice or estimated risk data from one or more professional risk systems may in part or in whole already reside in a database that has a sufficient level of information and would not need to be added to a separate database or be such that the existing database could be used to add other data to be processed in carrying out one or more operations from process 400 or as part of CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at OBTAIN PROFESSIONAL CLAIMS AND/OR MALPRACTICE DATA FROM ONE OR MORE PROFESSIONAL RISK SYSTEMS 403, additional data elements that describe the professional or a potential risk of the professional are gathered from additional systems or from the professional risk system or systems. For example, such additional data elements may include, but are not limited to, the following: name, license, years of practice, specialty, gender, identification number of any sort, other factors currently used in the art to classify or describe professionals and their practice or that may be used in the future to segment or describe professionals or their staff or environment in which they provide services.

In one embodiment, at OBTAIN PROFESSIONAL REVIEWS FOR ONE OR MORE PROFESSIONALS FROM ONE OR MORE ONLINE PROFESSIONAL RATINGS SYSTEMS 405, online data is gathered from one or more professional ratings systems and may be temporarily stored in memory before proceeding to CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at OBTAIN PROFESSIONAL REVIEWS FOR ONE OR MORE PROFESSIONALS FROM ONE OR MORE ONLINE PROFESSIONAL RATINGS SYSTEMS 405, online data and any other data are gathered as part of process for using online data to assess and present risk of professionals 200 to be used in CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at OBTAIN PROFESSIONAL REVIEWS FOR ONE OR MORE PROFESSIONALS FROM ONE OR MORE ONLINE PROFESSIONAL RATINGS SYSTEMS 405, online data is gathered from one or more professional ratings systems and may be entered directly into the database as part of CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at OBTAIN PROFESSIONAL REVIEWS FOR ONE OR MORE PROFESSIONALS FROM ONE OR MORE ONLINE PROFESSIONAL RATINGS SYSTEMS 405, online data from one or more professional ratings systems and/or other data from process for using online data to assess and present risk of professionals 200 may already reside in a database that has a sufficient level of information and would not need to be added to a separate database or the existing database could be used to add other data to be processed in carrying out one or more operations from process 400 or as part of CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

Returning to FIG. 4, in one embodiment, once online data and risk data are obtained at OBTAIN PROFESSIONAL CLAIMS AND/OR MALPRACTICE DATA FROM ONE OR MORE PROFESSIONAL RISK SYSTEMS 403 and/or OBTAIN PROFESSIONAL REVIEWS FOR ONE OR MORE PROFESSIONALS FROM ONE OR MORE ONLINE PROFESSIONAL RATINGS SYSTEMS 405, process flow proceeds to CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 a professional online data and risk database is created using the online data relating to the professionals obtained at OBTAIN PROFESSIONAL CLAIMS AND/OR MALPRACTICE DATA FROM ONE OR MORE PROFESSIONAL RISK SYSTEMS 403 and/or risk data obtained in OBTAIN PROFESSIONAL REVIEWS FOR ONE OR MORE PROFESSIONALS FROM ONE OR MORE ONLINE PROFESSIONAL RATINGS SYSTEMS 405.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 the data pertaining to the professional are stored in the professional online data and risk database based on one or more parameters related to the professional or online data. Examples of the parameters include, but are not limited to, the following: name, license, years of practice, specialty, gender, identification number of any sort, date of online data, origin, or category of online data.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 the data pertaining to the professional are normalized according to according to various practices known at the time of filing or developed thereafter and stored according to one or more parameters related to the professional, risk, or online data.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 the data are cleaned according to various practices known at the time of filing or developed thereafter including, but not limited to, identifying permutations of professionals' names, identifying duplicate online data or specific elements of online data, combining professionals, deduplicating multiple redundant entries corresponding to a professional, indexing, identifying potential outliers or inaccurate data, and including or excluding data as appropriate in the cleaned professional online data and risk database.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 a portion or all of the online data, risk data, or descriptive data may already be present in an existing database that can be used to carry out one or more operations from process 400.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 the professional online data and risk database may include data elements for professionals including, but not limited to, descriptive factors of the professional or their staff or environment, other reviews or data related to the professional such as past claims, referrals, practice locations and geographies, photographs, audio or video recordings, social media references, blogs, ratings, reviews, comments from one or multiple online professional review systems, past claims history including pertinent claims dates, a method for associating the claim to a specific physician such as, but not limited to, medical license number, claim counts and claim amounts for the professional, all claims and relevant associated data whether settled, paid, dismissed or otherwise.

In one embodiment, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 other data such as, but not limited to, descriptive factors of the professional or their staff or environment, other reviews or data related to the professional such as past claims, referrals, practice locations and geographies, photographs, audio or video recordings, social media references, blogs reside in whole or in part in one or more separate databases but is/are correlated to the online data and/or risk data in the professional database to aid in the analysis of the professional.

In many embodiments of the present disclosure, at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 optimally, a sufficient number of data records for a sufficient number of professionals are included to provide statistical significance for the desired level of analysis conducted in process 400, for which an illustrative example which in no means should be construed to limit the scope of the disclosure, one embodiment would have sufficient data pertaining to a sufficient number of surgeons to provide a high level of statistical significance when looking at the correlation between surgeons broken out by gender and adjusted for years of practice to determine the relative risk for various cutoff categorizations such as quartiles, or deciles of the surgeons by the composite score for the surgeon derived from the online data.

In one embodiment, once a professional online data and risk database is created using the online data for one or more providers obtained at OBTAIN PROFESSIONAL CLAIMS AND/OR MALPRACTICE DATA FROM ONE OR MORE PROFESSIONAL RISK SYSTEMS 403 and/or OBTAIN PROFESSIONAL REVIEWS FOR ONE OR MORE PROFESSIONALS FROM ONE OR MORE ONLINE PROFESSIONAL RATINGS SYSTEMS 405 at CREATE A DATABASE USING ONLINE PROFESSIONAL RATINGS SYSTEMS AND MALPRACTICE AND/OR CLAIMS FOR SAME PROVIDERS FROM ONE OR MORE PROVIDER RISK SYSTEMS 407 process flow proceeds to ANALYZE RISK DATA AND PROFESSIONAL REVIEWS FOR ONE OR MORE PROFESSIONALS TO DETERMINE/IDENTIFY ALGORITHMS FOR STRATIFYING RISK 409.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409, risk assessments and stratifications of professionals utilize a standard scale, for example, but not to be limited to, a standard 0-100 point scale, a 5 point scale, a 4 point scale, or various other categorization schemes currently identified in the art today to which online data for the professional or professionals are normalized or adapted using one or more of many standard practices for normalization of data, including but not limited to, for example data transformations where data available in one scale is scaled up or down to fit the desired normalized scale.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 normalized online data for a professional or professionals are combined into a combined or aggregate score or metric using one of multiple methods including but not limited to, averaging, weighted average, a weighted calculation including one or more of the following, but not limited to, factors such as date of the contributed online data, contributing professional review system, professional specialty, number of online data records or other descriptive factor or factors.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 the professionals, once evaluated and each given a combined score or metric, are further categorized into logical groups including, but not limited to, stratifications according to percentages of the professional population being evaluated such as thirds, quartiles or deciles or uneven breakouts such as lowest 10%, middle 75% and top 15%, stratifications according to logical break points as determined by analyzing risk data and its correlation to the combined score or metric, or stratifications based on descriptive factors such as, but not limited to claim history, years of practice, and gender.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 the combined or aggregate scores or metrics derived from the normalized online data for a specific population of professionals are correlated and analyzed using statistical methods to the risk data for the same professionals in order to determine a relationship between the online data scores and risk. The resulting algorithm or algorithms is/are used in process for using online data to assess and present risk of professionals 200. For example, in one embodiment a population of surgeons will have their online data normalized and aggregated such that they each will receive a score of 1-100 with 100 being the best. Then, surgeons with similar scores will be aggregated along with their number of claims or other risk parameters. Statistical methods such as a chi squared test are used to determine if grouping the surgeons via the online data score creates a statistically significant algorithm for predicting risk of claims. Subsequent statistical analysis may allow for determining optimal groupings of scores in order to determine optimal algorithms and configurations of categories of statistically significant relative risk to the average surgeon of claims or malpractice.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 analysis and creation of algorithms considers the number of ratings for each professional to determine the composite score and in one embodiment is used to provide detail as to the confidence level that the composite score reasonably represents the professional's true risk category. For example, in one embodiment of the present disclosure, professionals with fewer than 5 ratings or online data records are assigned a confidence level of Low, professionals with 5-10 ratings or online records are assigned a High confidence level, and professionals with more than 10 ratings or online data records are assigned a Very High confidence level. In this manner, the algorithm may accurately reflect the risk corresponding to the professional as determined by the algorithm or algorithms.

In one embodiment of the present disclosure, ANALYZE RISK DATA AND PROFESSIONAL REVIEWS FOR ONE OR MORE PROFESSIONALS TO DETERMINE/IDENTIFY ALGORITHMS FOR STRATIFYING RISK 409 comprises analysis to generate algorithms that are resolved using or excluding professionals with various levels of ratings or online data records such as Low (0-5 ratings or online data records), High (6-10 ratings or online data records), and/or Very High (11+ ratings or online data records) categories of confidence, or other categorizations or groupings in order to determine if a more statistically significant or otherwise optimal algorithm would be created by including or excluding data on professionals with various levels of ratings or online data records.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 the optimal risk category range definitions and associated algorithm are determined by breaking out the professionals by one or more factors to categorize or separate out professionals by, for example but not limited to these examples, surgeons grouped in a category that includes one or more surgical specialties, and/or further segmented by gender, years of practice, medical school, previous claims, or other factors used to delineate groups of surgeons for risk purposes currently known in the current art or developed thereafter.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409, a composite score derived from the online data is first applied to the population of professionals being analyzed which is subsequently ranked according to the composite score and then segmented into groups such as, but not limited to, deciles, quartiles, fifths, or other percentage breakdowns. In one embodiment, risk correlation is then calculated for the resulting categories, and statistical methods are used to create resulting best fit algorithms that may be linear, power, logarithmic, polynomial, moving average, otherwise formulated according to other statistically derived methodologies, or combinations thereof for creating best fit analysis in order to provide the optimal equations for the desired range of analysis of the professionals in a process in actuality or similar to process for using online data to assess and present risk of professionals 200. In embodiments, the composite score may include one or more of an average, weighted average, maximum score out of ratings, minimum score out of ratings, median, average weighted according to one or more factors such as source of the ratings, or other statistical method of creating a composite score.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 the resulting algorithm or algorithms identified by evaluating the relationships between online data and risk data are further refined and segmented by first segmenting the data relative to a grouping of providers according to a factor or factors used in the art to delineate groups of professionals such as in an example where surgeons are segmented from obstetrics physicians before algorithms are calculated and modeled for malpractice risk, which furthermore may, for example, result in unique algorithm or algorithms for categorizing malpractice risk for surgeons and separate unique algorithms for categorizing malpractice risk for obstetrics physicians.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 the resulting risk stratification algorithm or algorithms include(s) one or more, together or severally of the following factors including, but not limited to: frequency of claims, severity of claims, risk relative to the dollar amount of claims, or other claims related risks such as, but not limited to, risk of claims that where no indemnity is paid and/or claims where an indemnity is paid and/or claims that are otherwise settled.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 creation, optimization, and maintenance of the algorithm or algorithms to determine relative risk is determined by statistical analysis using a database that includes historical risk data for professionals in the database.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 creation, optimization, and maintenance of the algorithm or algorithms to determine relative risk is performed by a prospective study where online data and professional descriptive factors are compiled and the risk data are gathered from a prospective time period to then be analyzed in conjunction with the professional online data to create an algorithm or algorithms to determine relative risk for professionals.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 creation, optimization, and maintenance of the algorithm or algorithms to determine one or more professionals' relative risk is performed by evaluating online data with a date in the past before a selected time and risk data after that selected time to determine relationships between online data and risk data to be used in process for using online data to assess and present risk of professionals 200.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 creation, optimization, and/or maintenance of the algorithm or algorithms to determine relative risk is performed using a combination of prospective risk and historical risk data as described in the paragraphs above.

In one embodiment of the present disclosure, at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 creation, optimization, and/or maintenance of the algorithm or algorithms to determine relative risk is performed using extracts of a part of all of the data in the professional online data and risk database.

In various embodiments of the present disclosure, at optional operation MONITOR RESULTS AND/OR OBTAIN FEEDBACK FROM THE USER AND/OR PROFESSIONALS AND/OR INCORPORATE FEEDBACK INTO THE PROCESS 411 any feedback or additional data obtained is used by the provider of process for using online data to determine risk for professionals 400 to improve algorithms developed in process for using online data to determine risk for professionals 400.

In one embodiment of the present disclosure, at MONITOR RESULTS AND/OR OBTAIN FEEDBACK FROM THE USER AND/OR PROFESSIONALS AND/OR INCORPORATE FEEDBACK INTO THE PROCESS 411 additional data on the accuracy of risk determinations for professionals provided as a result of process for using online data to assess and present risk of professionals 200 is gathered and used improve future analysis and/or creation, refining, or maintenance of algorithms developed in process for using online data to determine risk for professionals 400.

In one embodiment of the present disclosure, once one or more algorithms are identified or determined at ANALYZE RISK DATA AND PROFESSIONAL REVIEWS FOR ONE OR MORE PROFESSIONALS TO DETERMINE/IDENTIFY ALGORITHMS FOR STRATIFYING RISK 409 and are tracked, monitored, and other feedback received and incorporated back into the process at optional operation MONITOR RESULTS AND/OR OBTAIN FEEDBACK FROM THE USER AND/OR PROFESSIONALS AND/OR INCORPORATE FEEDBACK INTO THE PROCESS 411 process flow proceeds to EXIT 413.

In one embodiment at EXIT 413 process for using online data to determine risk for professionals 400 is exited to await new data or requests for further analysis. According to various embodiments, process 400 may be cycled repeatedly as additional data become available for entry into and/or analysis by risk assessment system 100 or as requests for further analysis are made.

Using process for using online data to determine risk for professionals 400, a professional risk assessment system is provided that takes into account the feedback and perceptions of users of the professional services via online data. The resulting analysis from process for using online data to assess and present risk of professionals 200 may allow insurance providers, credentialing offices, and others concerned with risk of professionals access to new inputs to aid in decision making processes including but not limited to pricing risk for malpractice insurance companies or other malpractice insurance constructs such as captives or risk retention groups, stratifying risk and optimize construction/segmentation within captive or risk retention group insurance constructs, evaluating professionals for privileges to practice at a facility (commonly referred to as a credentialing process), assessing professional practices for acquisition or partnership, determining an individual or group of professionals' propensity to receive future referrals and by extension the potential revenue generation, and/or aid facilities and practices in evaluating which professionals or staff should be targeted for interventions to help improve customer satisfaction or lower risk.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A computer-implemented method for assessing a risk comprising:
at an online data collection module, retrieving an item of online data pertaining to a professional;
associating the item of online data to the professional;
at a risk assessment module, assessing the risk for the professional based, at least in part, on the item of online data; and
providing a report regarding the risk for the professional.

2. The method of claim 1, wherein:
the professional comprises a healthcare professional and
assessing the risk for the professional comprises assessing a risk of a healthcare malpractice claim asserted against the healthcare professional.

3. The method of claim 1, wherein the risk comprises a risk of a malpractice claim asserted against the professional.

4. The method of claim 1, further comprising normalizing the item of online data.

5. The method of claim 1, wherein retrieving the item of online data pertaining to the professional further comprises gathering aggregated online data pertaining to the professional from multiple professional ratings systems.

6. The method of claim 5, wherein the aggregated online data comprises multiple evaluations regarding a service offered by the professional.

7. The method of claim 1, wherein the online data item comprises one item selected from the group consisting of: a rating, an evaluation, a review, a comment, a survey instrument, a video or audio journal, a post, a blog, a comment on social media, a photograph, a search result, and a recording.

8. The method of claim 1, wherein assessing the risk for the professional comprises determining the professional's risk relative to a risk for other professionals having one or more factors in common with the professional.

9. The method of claim 8, wherein the one or more factors are selected from the group consisting of: specialty, license, gender, years in the field, years of practice, professional school, geography of professional school, ongoing education, marital status, relationship status, similar online ratings and reviews for other professionals, geography, previous claims, previous malpractice, experience, cost of services, professional designations, membership in clubs, membership in associations, membership in fraternities, membership in other groups, criminal offenses, civil offenses, professional organization sanctions, business organization sanctions, discipline, and other actions, awards, distinctions, or other positive or negative designations or findings.

10. The method of claim 1, further comprising:
analyzing risk data and online data items for multiple other professionals to determine an algorithm for assessing the risk for the professional based, at least in part, on the item of online data.

11. A system for assessing a risk comprising:
a computer processor and
a non-transient memory containing computer-readable instructions to direct the computer processor to:
retrieve an item of online data pertaining to a professional;
normalize the item of online data to predetermined parameters; and
assess the risk for the professional based, at least in part, on the item of online data.

12. The system of claim 11, wherein the memory contains computer-readable instructions to further direct the computer processor to provide a report regarding the risk for the professional.

13. The system of claim 11, wherein the memory contains computer-readable instructions to further direct the computer processor to:
analyze risk data and online data items for multiple other professionals and
determine an algorithm for assessing the risk for the professional based, at least in part, on the item of online data.

14. A computer-implemented method for assessing a risk comprising:
retrieving online data pertaining to multiple professionals;
obtaining professional malpractice claims risk data pertaining to the multiple professionals;
for each selected professional, generating a risk assessment score based on a portion of the item of online data pertaining to the selected professional;
for the selected professional, determining a risk stratification based on a portion of the risk data pertaining to the selected professional; and
identifying a relationship between the risk stratification and the risk assessment score.

15. The method of claim 14, further comprising:
for the multiple professionals, generating a set of respective risk assessment scores based on a portion of the item of online data pertaining to each one of the multiple professionals;
for the multiple professionals, determining a set of respective risk stratifications based on a portion of the risk data pertaining to each one of the multiple professionals;
wherein identifying the relationship between the risk stratification and the risk assessment score further comprises determining a mathematical relationship between the set of respective risk assessment scores and the set of respective risk stratifications.

16. The method of claim 15, further comprising:
retrieving a new item of online data pertaining to a new professional and calculating a new risk stratification for the new professional by evaluating the new item of online data within the mathematical relationship.

17. The method of claim 14, further comprising calculating a confidence level for the risk stratification for the professional, the confidence level based, in part, on a quantity of risk data used to determine the risk stratification for the professional.

18. The method of claim 14, wherein generating the risk assessment score comprises determining the professional's risk relative to a risk for other professionals having one or more factors in common with the professional.

19. The method of claim 14, wherein the professionals comprise healthcare professionals.

20. The method of claim 14, wherein the online data pertaining to multiple professionals comprises evaluations regarding a service offered by the professionals.
